(19) United States
(12) Patent Application Publication
(10) Pub. No.: US 2019/0094260 A1
(43) Pub. Date: Mar. 28, 2019

(54) PHYSICAL QUANTITY SENSOR, PHYSICAL QUANTITY SENSOR APPARATUS, ELECTRONIC APPARATUS, AND VEHICLE

(71) Applicant: Seiko Epson Corporation, Tokyo (JP)

(72) Inventor: Atsuki NARUSE, Shiojiri (JP)

(21) Appl. No.: 16/140,699

(22) Filed: Sep. 25, 2018

(30) Foreign Application Priority Data
Sep. 26, 2017 (JP) 2017-184450

(51) Int. Cl. G01P 15/125; G01P 15/08

(52) U.S. Cl. CPC G01P 15/125; G01P 2015/0831; G01P 15/0802

(57) ABSTRACT

A physical quantity sensor includes a base substrate, a movable part placed to be displaceable with respect to the base substrate, a supporting part that supports the movable part, a dummy electrode provided on the movable part side of the base substrate and placed to face the movable part, a first conducting part provided on the base substrate side of the movable part and placed to face the dummy electrode, and a second conducting part provided on the base substrate side of the supporting part, wherein the first conducting part and the second conducting part are connected by a third conducting part.

### BACKGROUND

### 1. Technical Field

The present invention relates to a physical quantity sensor, physical quantity sensor apparatus, electronic apparatus, and vehicle.

### 2. Related Art

For example, a physical quantity sensor (acceleration sensor) disclosed in Patent Document 1 (JP-A-2013-40856) has a base substrate, a movable part that can seesaw-swing with respect to the base substrate, and an electrode provided on the base substrate and placed to face the movable part, and a capacitance is formed between the movable part and the electrode. In the physical quantity sensor, when an acceleration is applied, the movable part seesaw-swings, thereby, the capacitance changes, and thus, the applied acceleration is detected based on the change of the capacitance.

However, in the configuration of Patent Document 1, the movable part is formed using silicon, the electrode is formed using Pt, and the movable part and the electrode are electrically connected by silicon. Accordingly, there is a difference between the work function (amount of electric charge) of the movable part and the work function of the electrode and capacitance-voltage characteristics (hereinafter, referred to as “CV characteristics”) shift according to the work function difference as shown in FIG. 1, for example. Further, the characteristics are affected by Schottky barrier and trap level generated due to the work function difference at the interface between the movable part and the electrode and become unstable. There is a problem that acceleration detection accuracy is lower.

### SUMMARY

An advantage of some aspects of the invention is to solve at least a part of the problems described above, and the invention can be implemented as the following forms or application examples.

### Application Example 1

A physical quantity sensor according to this application example includes a substrate, a movable part placed to be displaceable with respect to the substrate, a supporting part that supports the movable part, an electrode provided on the movable part side of the substrate and placed to face the movable part, a first conducting part provided on the substrate side of the movable part and placed to face the electrode, and a second conducting part provided on the substrate side of the supporting part, wherein the first conducting part and the second conducting part are connected by a third conducting part.

According to this application example, the first conducting part provided on the movable part placed to face the electrode provided on the substrate and the second conducting part provided on the support part are connected by the third conducting part. Accordingly, the electrode and the movable part are electrically connected by the third conducting part and influences by Schottky barrier and trap level generated due to a work function difference at the interface between the electrode and the first conducting part provided on the movable part may be reduced. Therefore, the physical quantity sensor in which characteristic fluctuations may be suppressed and lowering of physical quantity detection accuracy may be reduced may be provided.

### Application Example 2

In the physical quantity sensor according to the application example, it is preferable that the electrode and the first conducting part are formed using the same material.

According to this application example, the electrode and the first conducting part are formed using the same material, and thus, the work function of the electrode and the work function of the first conducting part may be nearly made equal (that is, the work function difference may be made extremely closer to zero) and fluctuations of the CV characteristics may be reduced.

### Application Example 3

In the physical quantity sensor according to the application example, it is preferable that the third conducting part is provided on the substrate side of a coupling part that couples the movable part and the supporting part.

According to this application example, the third conducting part is provided on the substrate side of the coupling part that couples the movable part and the supporting part, and thereby, the third conducting part, the first conducting part, and the second conducting part may be formed at the same time by single deposition from the base substrate side.

### Application Example 4

In the physical quantity sensor according to the application example, it is preferable that the first conducting part and the third conducting part are formed using the same material.

According to this application example, the first conducting part and the third conducting part are formed using the same material, and thereby, the first conducting part and the third conducting part may be formed at the same time by single deposition.

### Application Example 5

In the physical quantity sensor according to the application example, it is preferable that the movable part has a first movable member located on one side and a second movable member located on the other side in which turning moment at application of an acceleration in a direction of an arrangement of the substrate and the movable part is larger than that of the first movable member, and the first movable member and the second movable member seesaw-swing with respect to the substrate.

According to this application example, the first movable member and the second movable member seesaw-swing with respect to the substrate, and thereby, the physical quantity sensor that may detect an acceleration in the thickness directions of the movable part may be provided.

### Application Example 6

In the physical quantity sensor according to the application example, it is preferable that the electrode has a first electrode placed to face the first movable member and a second electrode placed to face the second movable member.

According to this application example, the electrode has the first electrode placed to face the first movable member and the second electrode placed to face the second movable member, and thereby, the acceleration in the thickness directions of the movable part may be detected with higher accuracy.

### Application Example 7

In the physical quantity sensor according to the application example, it is preferable that the movable part has a base displaceable in in-plane directions of the movable part with respect to the substrate, and a movable electrode portion provided to project from the base.

According to this application example, the movable part has the base displaceable in the in-plane directions of the movable part with respect to the substrate, and the movable electrode portion provided to project from the base, and thereby, the physical quantity sensor that may detect an acceleration in the in-plane directions of the movable part may be provided.

### Application Example 8

In the physical quantity sensor according to the application example, it is preferable that the electrode is at the same potential as the movable part.

According to this application example, the electrode is at the same potential as the movable part, and thereby, sticking of the movable part to the base substrate may be reduced.

### Application Example 9

A physical quantity sensor apparatus according to this application example includes the physical quantity sensor according to the above described application example, and an electronic component electrically connected to the physical quantity sensor.

According to this application example, the physical quantity sensor having higher detection accuracy is utilized in the physical quantity sensor apparatus, and thereby, the physical quantity sensor apparatus with higher performance may be provided.

### Application Example 10

An electronic apparatus according to this application example includes the physical quantity sensor according to the above described application example.

According to this application example, the physical quantity sensor having higher detection accuracy is utilized in the electronic apparatus, and thereby, the electronic apparatus with higher performance may be provided.

### Application Example 11

A vehicle according to this application example includes the physical quantity sensor according to the above described application example.

According to this application example, the physical quantity sensor having higher detection accuracy is utilized in the vehicle, and thereby, the vehicle with higher performance may be provided.

### BRIEF DESCRIPTION OF THE DRAWINGS

Embodiments of the invention will be described with reference to the accompanying drawings, wherein like numbers reference like elements.

FIG. 1 is a graph showing capacitance-voltage characteristics.

FIG. 2 is a plan view showing a physical quantity sensor according to a first embodiment.

FIG. 3 is a sectional view along line A-A in FIG. 2.

FIG. 4 is a sectional view along line C-C in FIG. 2.

FIG. 5 is a sectional view for explanation of a method of manufacturing a functional device element.

FIG. 6 is a sectional view for explanation of the method of manufacturing the functional device element.

FIG. 7 is a sectional view for explanation of the method of manufacturing the functional device element.

FIG. 8 is a sectional view for explanation of the method of manufacturing the functional device element.

FIG. 9 is a schematic diagram for explanation of driving of the physical quantity sensor shown in FIG. 2.

FIG. 10 is a schematic diagram for explanation of driving of the physical quantity sensor shown in FIG. 2.

FIG. 11 is a schematic diagram for explanation of driving of the physical quantity sensor shown in FIG. 2.

FIG. 12 is a plan view showing a physical quantity sensor according to a second embodiment.

FIG. 13 is a sectional view along line D-D in FIG. 12.

FIG. 14 is a sectional view along line E-E in FIG. 12.

FIG. 15 is a plan view showing a physical quantity sensor according to a third embodiment.

FIG. 16 is a sectional view along line F-F in FIG. 15.

FIG. 17 is a sectional view showing a configuration of a physical quantity sensor apparatus.

FIG. 18 is a perspective view showing a configuration of a mobile (or notebook) personal computer to which the physical quantity sensor is applied.

FIG. 19 is a perspective view showing a configuration of a cell phone (including PHS) to which the physical quantity sensor is applied.

FIG. 20 is a perspective view showing a configuration of a digital still camera to which the physical quantity sensor is applied.

FIG. 21 is a perspective view showing an automobile to which the physical quantity sensor is applied.

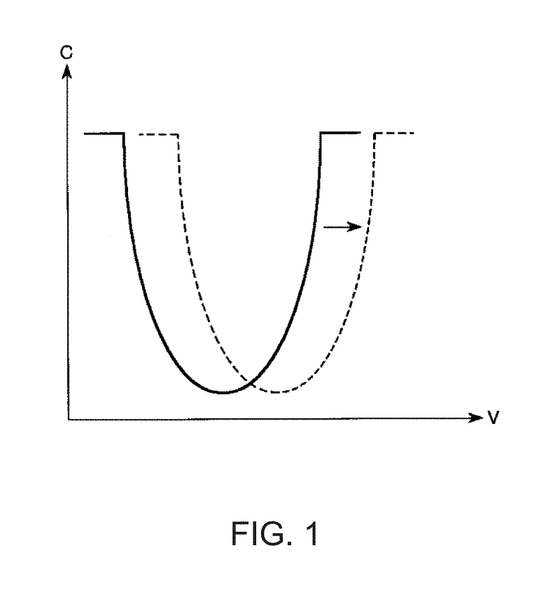

### DESCRIPTION OF EXEMPLARY EMBODIMENTS

As below, embodiments of the invention will be explained in detail based on the drawings. Note that, in the following respective drawings, dimensions and ratios of the respective component elements may be appropriately made different from actual component elements for providing sizes in which the respective component elements may be recognized on the drawings.

### 1. Physical Quantity Sensor

### First Embodiment

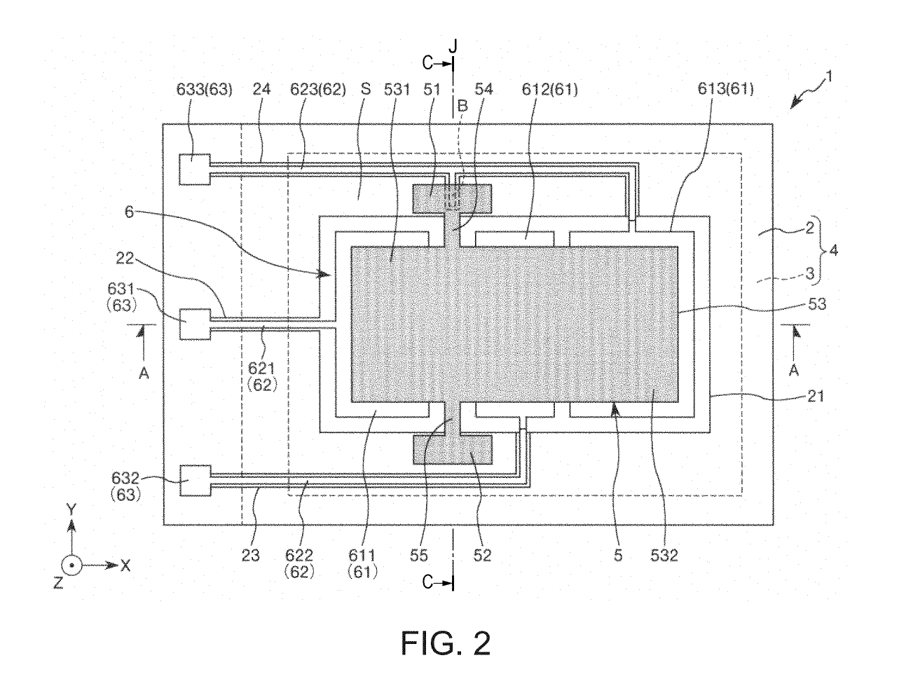

First, a physical quantity sensor 1 according to the first embodiment of the invention will be explained with reference to FIGS. 2 to 8.

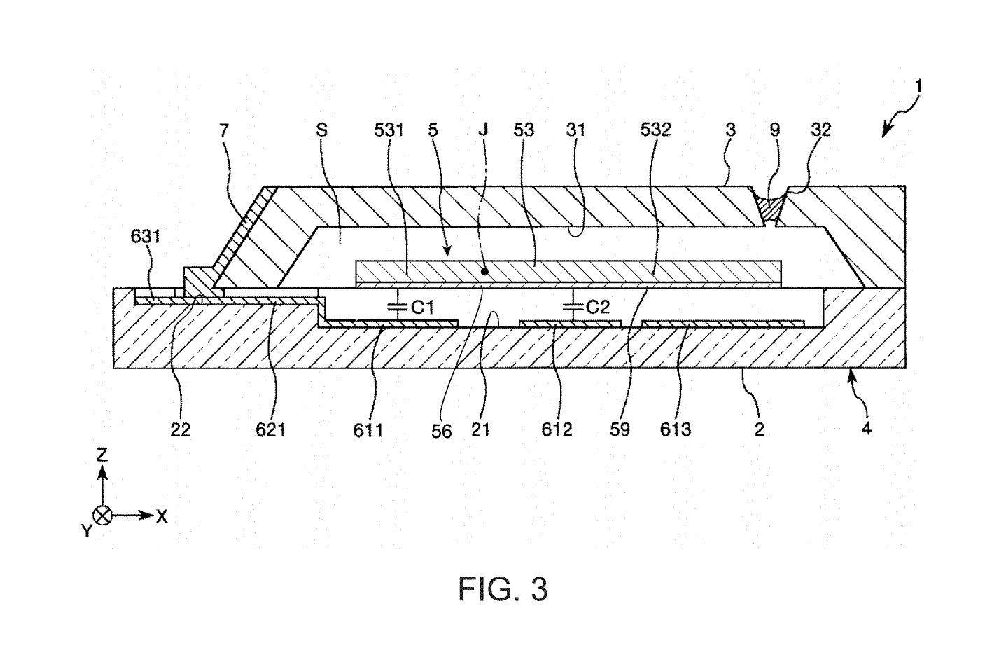

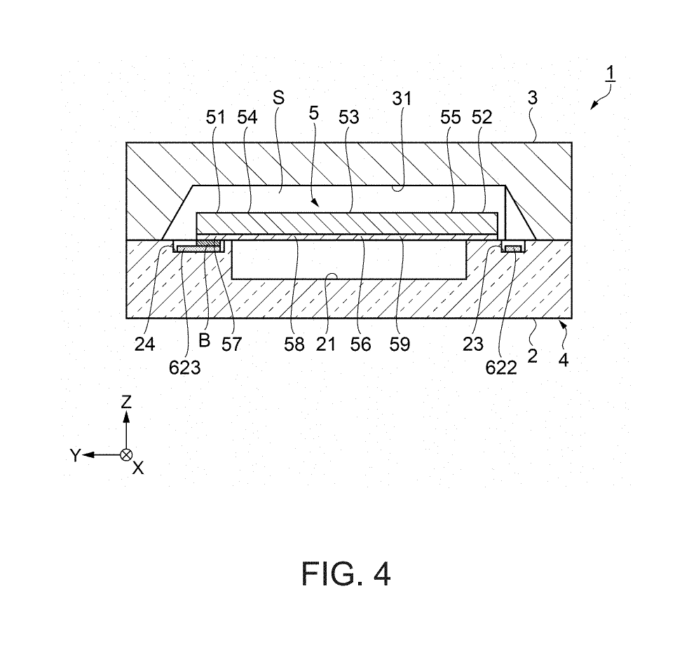

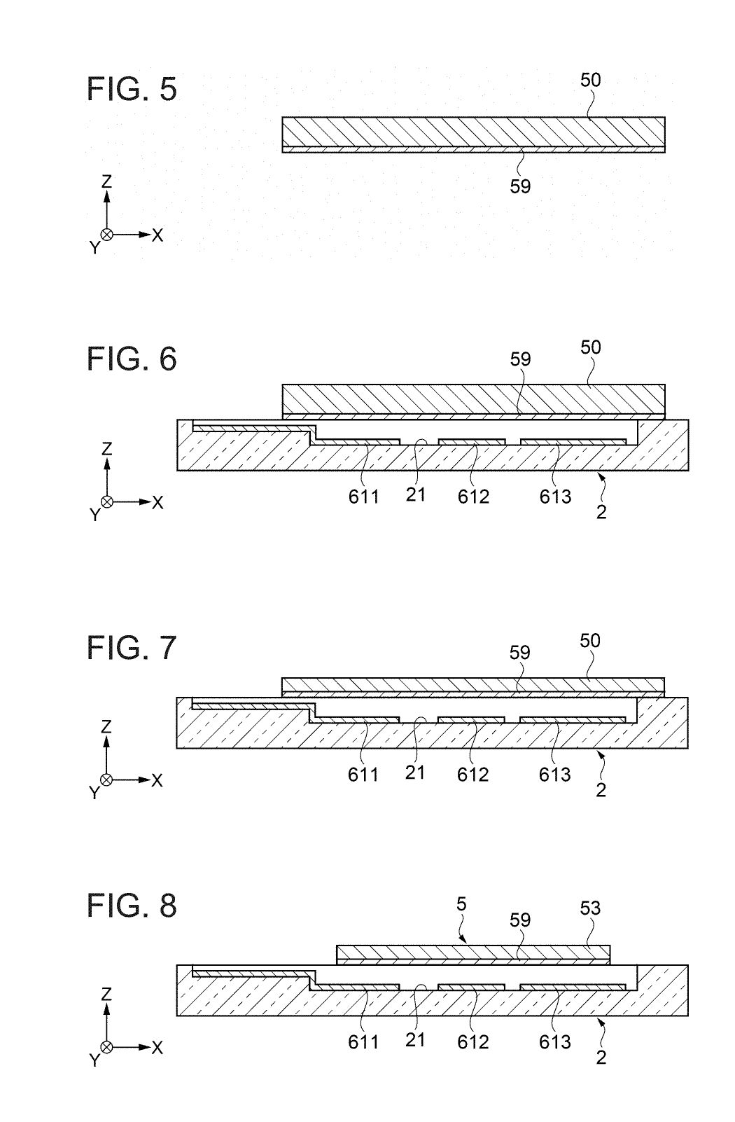

FIG. 2 is a plan view showing the physical quantity sensor according to the first embodiment of the invention. FIG. 3 is a sectional view along line A-A in FIG. 2, and FIG. 4 is a sectional view along line C-C in FIG. 2. FIGS. 5 to 8 are respectively sectional views for explanation of a method of manufacturing a functional device element. Note that, hereinafter, for convenience of explanation, the front side of the paper surface in FIG. 2 may be referred to as “upper” and the deep side of the paper surface may be referred to as “lower”. Further, in FIGS. 2 to 4 and the following FIGS. 5 to 17, an X-axis, Y-axis, and Z-axis are shown as three axes orthogonal to one another. Furthermore, hereinafter, directions parallel to the X-axis may be referred to as “X-axis directions”, directions parallel to the Y-axis may be referred to as “Y-axis directions”, and directions parallel to the Z-axis may be referred to as “Z-axis directions”. The Z-axis directions are parallel to the vertical directions and the XY-plane is along the horizontal plane.

As shown in FIGS. 2, 3 and 4, the physical quantity sensor 1 is an acceleration sensor that may measure an acceleration in the Z-axis directions (vertical directions). The physical quantity sensor 1 has a package 4 including a base substrate 2 as a substrate and a lid 3, a functional device element 5 housed in an internal space S of the package 4, and a conductor pattern 6 placed on the base substrate 2. As below, the component elements will be sequentially explained.

### Base Substrate

A recess 21 opening in the upper surface is formed in the base substrate 2. The recess 21 functions as a clearance part that prevents contact between the functional device element 5 and the base substrate 2. Further, the base substrate 2 opens in the upper surface and has three grooves 22, 23, 24 connected to the recess 21 formed therein. Wires 62 are respectively placed within the grooves 22, 23, 24. The base substrate 2 is formed using a glass substrate and has an outer shape formed by etching or the like. Note that the base substrate 2 is not limited to the glass substrate, but e.g. a silicon substrate or the like may be used.

### Functional Device Element

The functional device element 5 is provided in the upper part of the base substrate 2. The functional device element 5 has a movable part 53, coupling parts 54, 55 that swingably support the movable part 53, supporting parts 51, 52 that support the coupling parts 54, 55. The movable part 53 can seesaw-swing with respect to the supporting parts 51, around the coupling parts 54, 55 as an axis J while torsionally deforming the coupling parts 54, 55.

The movable part 53 has a longitudinal shape extending in the X-directions, and has a first movable member 531 located on one side in the X-axis direction with respect to the axis J and a second movable member 532 located on the other side in the +X-axis direction with respect to the axis J. Further, the second movable member 532 is longer than the first movable member 531 in the X-axis directions, and turning moment at application of an acceleration in the vertical directions (Z-axis directions) is larger than that of the first movable member 531. Due to the difference in turning moment, when an acceleration in the vertical directions is applied, the movable part 53 seesaw-swings around the axis J.

Note that the shapes of the first movable member 531 and the second movable member 532 are not particularly limited as long as the portions have different turning moment from each other. For example, the shapes may be the same in the plan view, but different in thickness. Or, the shapes may be the same, but a weight portion may be placed on one of them. Or, to reduce the resistance at seesaw swing, slits (through holes penetrating in the thickness directions) may be formed in the first movable member 531 and the second movable member 532.

As shown in FIGS. 3 and 4, a conducting film 59 is provided on the lower surfaces of the movable part 53 and the coupling parts 54, 55 (the surfaces facing the bottom surface of the recess 21) and the lower surfaces of the supporting parts 51, 52 (the surfaces facing the upper surface of the base substrate 2). The conducting film 59 is electrically connected to the movable part 53 having conductivity at the same potential with the movable part 53. Further, the conducting film 59 provided on the movable part 53 is a first conducting part 56, the conducting film 59 provided on the supporting parts 51, 52 is a second conducting part 57, and the conducting film 59 provided on the coupling parts 54, 55 is a third conducting part 58. Therefore, the movable part 53, the coupling parts 54, 55, and the supporting parts 51, 52 are electrically connected via the conducting film 59 and the movable part 53, the coupling parts 54, 55, and the supporting parts 51, 52 and the first conducting part 56, the second conducting part 57, and the third conducting part 58 are at the same potential. That is, the first conducting part 56 and the second conducting part 57 are electrically connected by the third conducting part 58. Accordingly, a dummy electrode 613, which will be described later, and the first conducting part 56 provided on the movable part 53 are electrically connected at the same potential by the third conducting part 58 provided on the coupling parts 54, 55, and, compared to the electrical connection via the conducting coupling parts 54, 55, influences by Schottky barrier and trap level generated due to the work function difference at the interface between the dummy electrode 613 and the first conducting part 56 may be reduced.

In the embodiment, the conducting film 59 is formed using Pt (platinum). Note that the constituent material of the conducting film 59 is not limited to Pt as long as the material has conductivity. For example, the material includes another metal material of Au, Ag, Cu, Al, or the like (including metal alloy) than Pt and an oxide conducting material such as ITO (Indium Tin Oxide), IZO (Indium Zinc Oxide), In₃O₃, SnO₂, Sb-containing SnO₂, or Al-containing ZnO, and one or two of the materials may be combined for use.

The supporting parts 51, 52 are placed on both sides with the movable part 53 in between and joined to the upper surface of the base substrate 2. In the supporting part 51, the second conducting part 57 provided on the lower surface and a conducting bump B provided on the wire 623 placed in the groove 24 are joined and the second conducting part 57 and the wire 623 are electrically connected. Further, the coupling parts 54, 55 extend along the Y-axis directions, and the coupling part 54 couples the supporting part 51 and the movable part 53 and the coupling part 55 couples the supporting part and the movable part 53. The configurations of the supporting parts 51, 52 and the coupling parts 54, 55 are not particularly limited as long as the parts may seesaw-swing the movable part 53.

The functional device element 5 is formed using a silicon substrate. Thereby, processing with higher accuracy can be performed by etching, and the functional device element 5 having the better outer shape may be obtained. Further, the functional device element 5 (supporting parts 51, 52) may be joined to the base substrate 2 by anodic bonding, and thus, the physical quantity sensor 1 with higher mechanical strength may be obtained. Furthermore, the silicon substrate is doped with an impurity of phosphorus, boron, or the like and the functional device element 5 is provided with conductivity.

Note that the material of the functional device element 5 is not limited to silicon, but e.g. another semiconductor substrate may be used. Further, the method of providing conductivity to the functional device element 5 is not limited to doping, but a conductor layer of a metal or the like may be formed on the surface of the movable part 53, for example.

The method of forming the above described functional device element 5 is briefly explained. First, as shown in FIG. 5, a silicon substrate (e.g. P-type silicon substrate) 50 doped with an impurity is prepared and the conducting film 59 is deposited on the lower surface of the silicon substrate 50. Accordingly, in the subsequent patterning, the first conducting part 56, the second conducting part 57, and the third conducting part 58 may be formed using the same material by single deposition at the same time. Then, as shown in FIG. 6, the silicon substrate 50 and the base substrate 2 are anodically bonded. Then, as shown in FIG. 7, the silicon substrate 50 is thinned to a predetermined thickness. Then, the silicon substrate 50 is patterned by dry etching or the like. In the above described manner, as shown in FIG. 8, the functional device element 5 joined to the base substrate 2 is obtained.

### Conductor Pattern

The conductor pattern 6 has electrodes 61, the wires 62, and terminals 63. Further, the electrodes 61 are provided on the bottom surface of the recess 21 and have a first detection electrode 611 as a first electrode, a second detection electrode 612 as a second electrode, and the dummy electrode 613. The first detection electrode 611 is placed to face the first movable member 531, and thereby, a capacitance C1 is formed between the first detection electrode 611 and the first movable member 531. Further, the second detection electrode 612 is placed to face the second movable member 532, and thereby, a capacitance C2 is formed between the second detection electrode 612 and the second movable member 532. These first detection electrode 611 and second detection electrode 612 are placed symmetrically with respect to the axis J in the plan view as seen from the Z-axis direction, and the capacitances C1, C2 without application of an acceleration are nearly equal to each other.

Further, the dummy electrode 613 is placed over the area without the first detection electrode 611 or second detection electrode 612 of the bottom surface of the recess 21. The dummy electrode 613 is at the same potential as the first conducting part 56 provided in the movable part 53, as will be described later, and thereby, an electrostatic force generated when the silicon substrate to be the functional device element 5 and the base substrate 2 are anodically bonded may be reduced and sticking of the silicon substrate to the base substrate 2 may be effectively suppressed.

The wires 62 have a wire 621 placed in the groove 22 and electrically connected to the first detection electrode 611, a wire 622 placed in the groove 23 and electrically connected to the second detection electrode 612, and a wire 623 placed in the groove 24 and electrically connected to the dummy electrode 613 and electrically connected to the functional device element 5 via the conducting bump B. Further, the terminals 63 have a terminal 631 placed in the groove 22 and electrically connected to the wire 621, a terminal 632 placed in the groove 23 and electrically connected to the wire 622, and a terminal 633 placed in the groove 24 and electrically connected to the wire 623. These terminals 631, 632, 633 are respectively exposed out of the package 4 and can be electrically connected to external apparatuses.

In the embodiment, the conductor pattern 6 is formed using Pt (platinum). The same material as that of the conducting film 59 is used and the work functions of the dummy electrode 613 and the first conducting part 56 may be made nearly equal and shifting of the CV characteristics may be reduced. Thereby, the electrical resistivity of the conductor pattern 6 may be made lower and reduction of noise and improvement of response characteristics may be realized. Further, the conductor pattern 6 with higher temperature characteristics (reliability for temperature) is obtained. Note that, as appropriate, to improve adhesion between the conductor pattern 6 and the base substrate 2, a foundation layer (e.g. Ti layer) may be placed between them.

The constituent material of the conductor pattern 6 is not limited to Pt as long as the material has conductivity. For example, the material includes another metal material of Au, Ag, Cu, Al, or the like (including metal alloy) than Pt and an oxide conducting material such as ITO (Indium Tin Oxide), IZO (Indium Zinc Oxide), In₃O₃, SnO₂, Sb-containing SnO₂, or Al-containing ZnO, and one or two of the materials may be combined for use. Or, for example, the constituent materials are different for the electrodes 61, the wires 62, and the terminals 63.

### Lid

The lid 3 has a recess 31 opening in the lower surface and joined to the base substrate 2 to form the internal space S by the recess 21 and the recess 31. The lid 3 is formed using a silicon substrate. Thereby, the lid 3 and the base substrate 2 may be joined by anodic bonding. Note that the lid 3 may be formed using e.g. a glass substrate.

Inside and outside of the internal space S communicate via the grooves 22, 23, 24, and, in the embodiment, the grooves 22, 23, 24 are closed by an SiO₂ film 7 formed by TEOSCVD method or the like. Further, the lid 3 has a communication hole 32 for communication of inside and outside of the internal space S. The communication hole 32 is a hole for setting the internal space S in a desired environment, and sealed by a sealing member 9 after setting the internal space S in the desired environment.

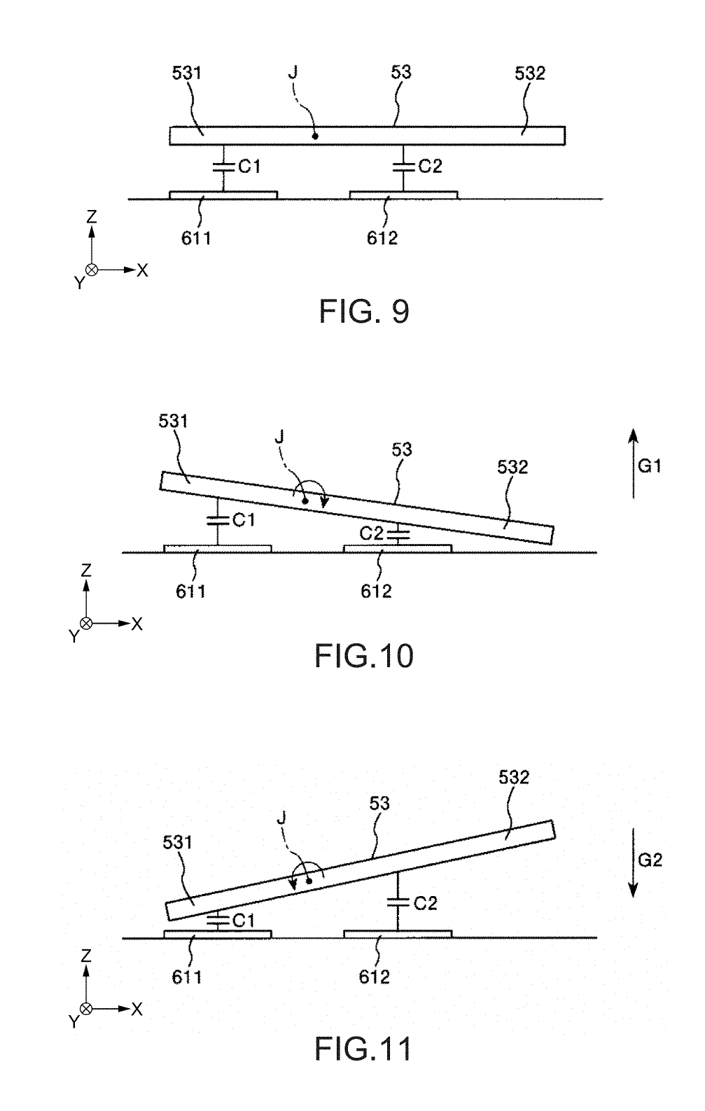

Next, driving of the physical quantity sensor 1 will be explained with reference of FIGS. 9, 10, and 11.

FIGS. 9 to 11 are schematic diagrams for explanation of driving of the physical quantity sensor shown in FIG. 2.

The above described physical quantity sensor 1 may sense an acceleration in the vertical directions (Z-axis directions) in the following manner. As shown in FIG. 9, when an acceleration in the vertical directions is not applied to the physical quantity sensor 1, the movable part 53 maintains the horizontal state. Then, when an acceleration G1 upward in the vertical directions (+Z-axis direction) is applied to the physical quantity sensor 1, as shown in FIG. 10, the movable part 53 seesaw-swings clockwise around the axis J. Oppositely, an acceleration G2 downward in the vertical directions (−Z-axis direction) is applied to the physical quantity sensor 1, as shown in FIG. 11, the movable part 53 seesaw-swings counterclockwise around the axis J. By the seesaw-swing of the movable part 53, the separation distance between the first movable member 531 and the first detection electrode 611 and the separation distance between the second movable member 532 and the second detection electrode 612 change and, accordingly, the capacitances C1, C2 change. Therefore, the magnitude and direction of the acceleration may be detected based on the difference between the capacitances C1, C2 (differential detection method). Particularly, the acceleration may be detected with higher accuracy using the differential detection method.

As described above, the physical quantity sensor 1 according to the first embodiment has the following features.

The first conducting part 56 provided on the movable part 53 placed to face the dummy electrode 613 provided on the base substrate 2 and the second conducting part 57 provided on the supporting part 51 electrically connected to the dummy electrode 613 via the wire 623 and the bump B are electrically connected by the third conducting part 58 provided on the coupling part 54. Accordingly, compared to the electrical connection via the conducting coupling parts 54, 55, influences by Schottky barrier and trap level generated due to the work function difference at the interface between the dummy electrode 613 and the first conducting part 56 may be reduced. Therefore, the physical quantity sensor 1 in which characteristic fluctuations may be suppressed and lowering of acceleration detection accuracy may be reduced may be provided.

Further, the dummy electrode 613 and the first conducting part 56 are formed using the same material Pt (platinum), and the work function of the dummy electrode 613 and the work function of the first conducting part 56 may be made equal (that is, the work function difference may be made extremely closer to zero) and shifting of the CV characteristics as described in “Related Art” may be reduced.

As another advantage, contact charging between the first detection electrode 611 and second detection electrode 612 and the first conducting part 56 may be reduced, and thus, for example, when the movable part 53 excessively swings into contact with the bottom surface of the recess 21, sticking of the movable part 53 to the base substrate 2 may be reduced. As yet another advantage, if an outgas is generated within the internal space S and the outgas adheres to the surfaces of the first detection electrode 611 and second detection electrode 612 and the first conducting part 56, these surfaces are maintained in the same charged state as one another. Accordingly, the difference between work functions over time may be reduced.

Note that, for example, even when all of the first detection electrode 611 and second detection electrode 612 and the first conducting part 56 are formed using a different material (e.g. ITO) from Pt, naturally, the same time advantage as described above may be offered.

The third conducting part 58 is provided on the base substrate 2 side of the coupling part 54 coupling the movable part 53 and the supporting part 51, and thereby, the third conducting part 58, the first conducting part 56, and the second conducting part 57 may be formed at the same by single deposition from the base substrate 2 side.

The first conducting part 56 and the third conducting part 58 are formed using the same material, and thereby, the first conducting part 56 and the third conducting part 58 may be formed at the same time by single deposition.

The first movable member 531 and the second movable member 532 seesaw-swing with respect to the base substrate 2, and thereby, the physical quantity sensor 1 that may detect the acceleration in the thickness directions (Z-axis directions) of the movable part 53 may be provided.

The electrodes 61 have the first detection electrode 611 placed to face the first movable member 531 and the second detection electrode 612 placed to face the second movable member 532, and thereby, the acceleration in the thickness directions of the movable part 53 may be detected with higher accuracy.

### Second Embodiment

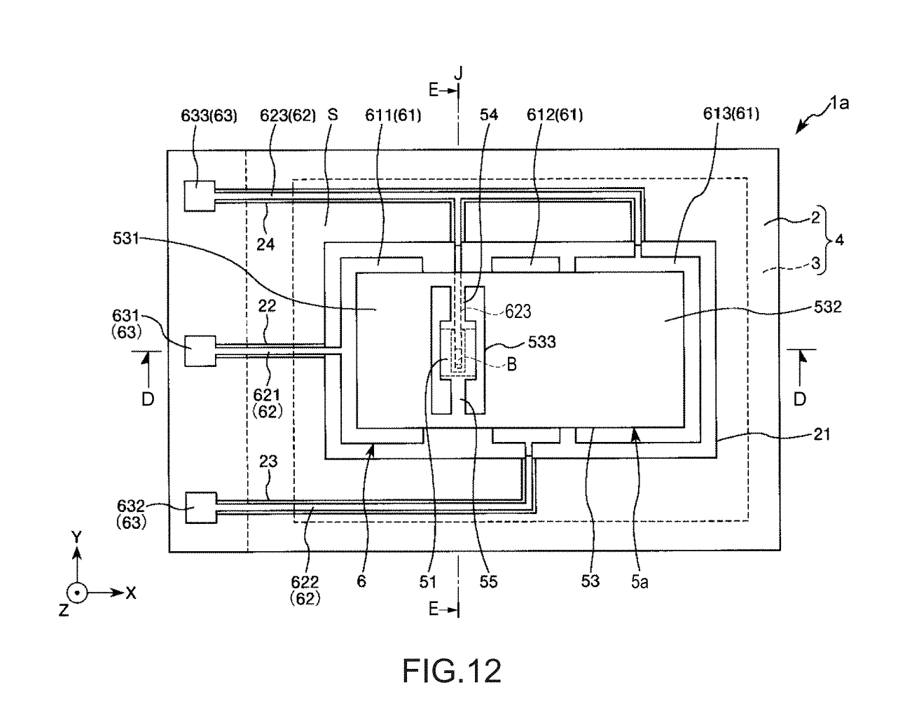

Next, a physical quantity sensor 1a according to the second embodiment of the invention will be explained with reference to FIGS. 12 to 14.

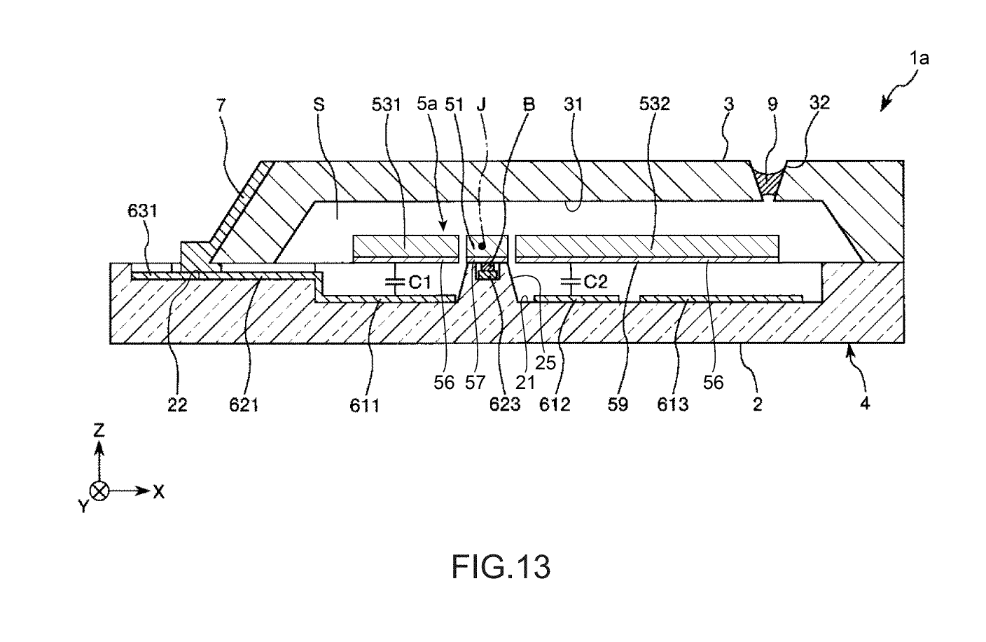

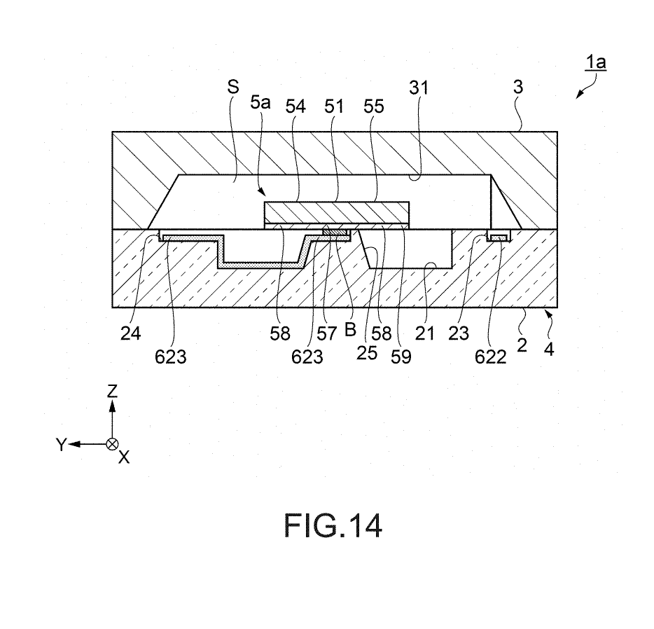

FIG. 12 is a plan view showing the physical quantity sensor according to the second embodiment of the invention. FIG. 13 is a sectional view along line D-D in FIG. 12, and FIG. 14 is a sectional view along line E-E in FIG. 12.

The physical quantity sensor 1a according to the embodiment is the same as the physical quantity sensor 1 according to the above described first embodiment mainly except that the configuration of a functional device element 5a is different.

In the following description, the physical quantity sensor 1a of the second embodiment will be explained with a focus on differences from the above described embodiment, and the explanation of the same items will be omitted. In FIGS. 12, 13, and 14, the same configurations as those of the above described embodiment have the same signs.

As shown in FIGS. 12, 13, and 14, the functional device element 5a includes a supporting part 51, a movable part 53, and coupling parts 54, 55 that couple the supporting part 51 and the movable part 53. An opening 533 is formed between a first movable member 531 and a second movable member 532 of the movable part 53, and the supporting part 51 to be fixed to a base substrate 2 is provided within the opening 533. The supporting part 51 is fixed to an upper surface of a projection 25 provided within a recess 21 of the base substrate and onto a bump B placed on a wire 623. Therefore, a first conducting part 56 as a conducting film 59 provided on the movable part 53 and a second conducting part 57 as the conducting film 59 provided on the supporting part 51 are electrically connected by a third conducting part 58 as the conducting film 59 provided on the coupling parts 54, 55, and the wire 623 and the second conducting part 57 are electrically connected via the bump B. Thus, the first conducting part 56 and a dummy electrode 613 are electrically connected via the third conducting part 58 and the wire 623 at the same potential.

Note that, in the configuration in which the movable part 53 is fixed by the supporting part 51 within the opening 533, the functional device element 5a may be downsized because the supporting part 51 and the coupling parts 54, 55 are not placed outside of the movable part 53 compared to the above described first embodiment, for example. Further, the supporting part 51 supported by the base substrate 2 is placed inside of the first movable member 531, and thereby, distortion due to reduction of stress propagation from the base substrate 2 to the movable part 53 may be reduced.

According to the second embodiment, the same advantages as those of the above described first embodiment may be offered.

### Third Embodiment

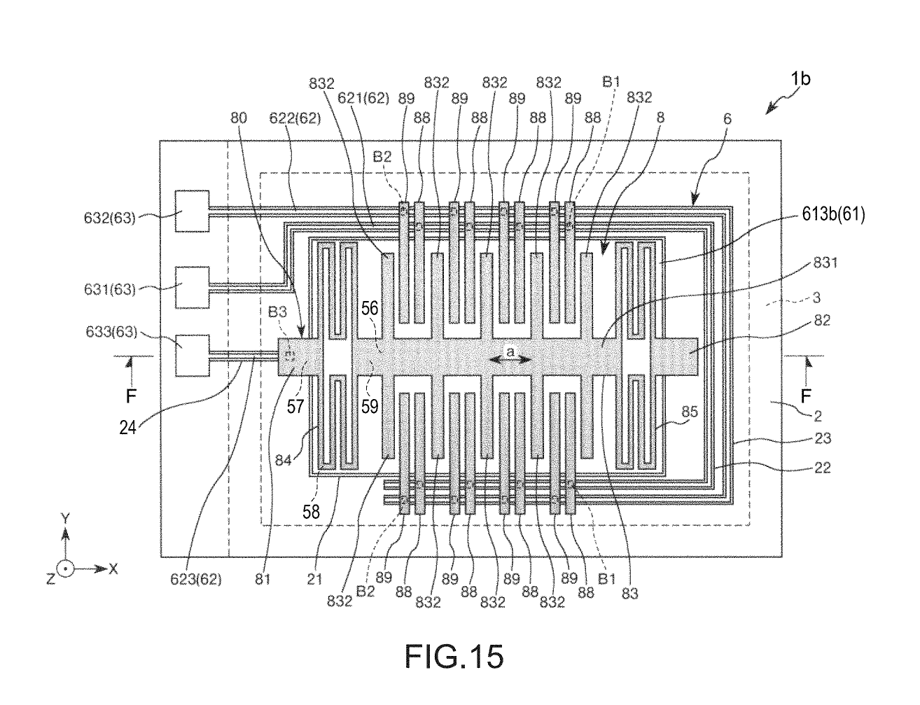

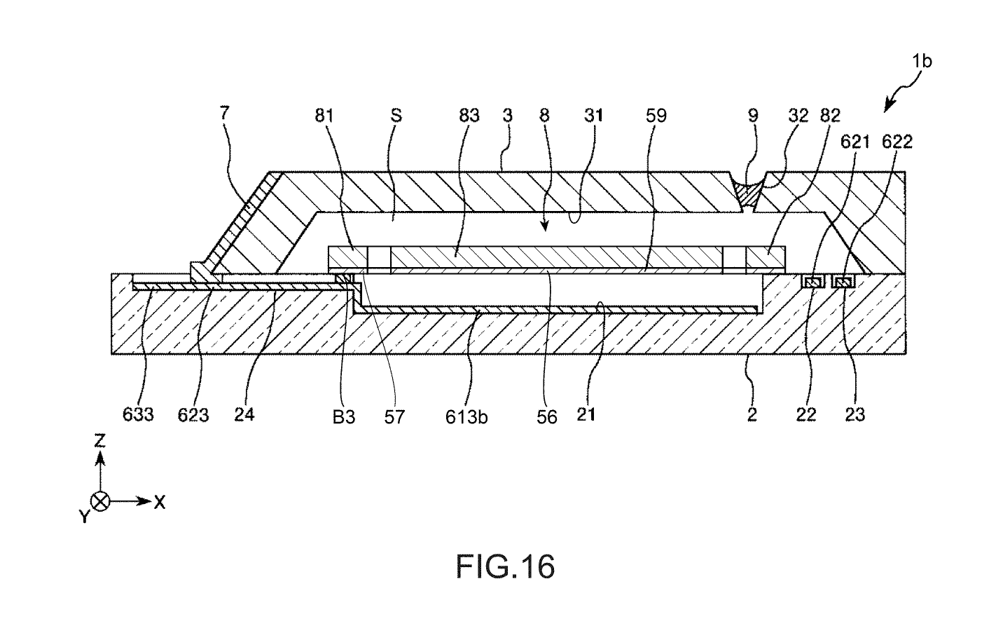

Next, a physical quantity sensor 1b according to the third embodiment of the invention will be explained with reference to FIGS. 15 and 16.

FIG. 15 is a plan view showing the physical quantity sensor according to the third embodiment of the invention. FIG. 16 is a sectional view along line F-F in FIG. 15.

The physical quantity sensor 1b according to the embodiment is the same as the physical quantity sensor according to the above described first embodiment mainly except that the configuration of a functional device element 8 is different.

In the following description, the physical quantity sensor 1b of the third embodiment will be explained with a focus on differences from the above described embodiments, and the explanation of the same items will be omitted. In FIGS. 15 and 16, the same configurations as those of the above described embodiments have the same signs.

As shown in FIGS. 15 and 16, the functional device element 8 is an element that may measure an acceleration in the X-axis directions (in-plane directions of the functional device element 8). The functional device element 8 has a movable structure 80 including supporting parts 81, 82, a movable part 83, and coupling parts 84, 85, a plurality of first fixed electrode fingers 88, and a plurality of second fixed electrode fingers 89. Further, the movable part 83 has a base 831 and movable electrode fingers 832 as a plurality of movable electrode portions projecting from the base 831 toward both sides in the Y-axis directions. The functional device element 8 is formed using a silicon substrate doped with an impurity of phosphorus, boron, or the like.

The supporting parts 81, 82 are joined to an upper surface of a base substrate 2 and, in the supporting part 81, electrically connected to a wire 623 via a conducting bump B3. The movable part 83 is provided between these supporting parts 81, 82, and the movable part 83 is coupled to the supporting part 81 via the coupling part 84 and coupled to the supporting part 82 via the coupling part 85. Thereby, the movable part 83 is displaceable in the X-axis directions as shown by an arrow a with respect to the supporting parts 81, 82 while elastically deforming the coupling parts 84, 85. A conducting film 59 is provided on the lower surface of the functional device element 8. Therefore, a first conducting part 56 as the conducting film 59 provided on the movable part 83 and a second conducting part 57 as the conducting film 59 provided on the supporting parts 81, 82 are electrically connected by a third conducting part 58 as the conducting film 59 provided on the coupling parts 84, 85, and the wire 623 and the second conducting part 57 are electrically connected via the bump B3. Thus, the movable part 83 with the first conducting part 56 provided thereon and a dummy electrode 613b are electrically connected via the third conducting part 58 and the wire 623 at the same potential.

The plurality of first fixed electrode fingers 88 are placed on one sides of the respective movable electrode fingers 832 in the X-axis directions and arranged in tooth shapes meshing with the corresponding movable electrode fingers 832 with gaps in between. Further, the respective first fixed electrode fingers 88 are joined to the upper surface of the base substrate 2 in the base end portions. The respective first fixed electrode fingers 88 are electrically connected to a wire 621 via conducting bumps B1.

On the other hand, the plurality of second fixed electrode fingers 89 are placed on the other sides of the respective movable electrode fingers 832 in the X-axis directions and arranged in tooth shapes meshing with the corresponding movable electrode fingers 832 with gaps in between. Further, the respective second fixed electrode fingers 89 are joined to the upper surface of the base substrate 2 in the base end portions. The respective second fixed electrode fingers 89 are electrically connected to a wire 622 via conducting bumps B2.

A dummy electrode 613b (electrode 61) is placed on a bottom surface of a recess 21 (a part facing the movable part 83). The dummy electrode 613b is formed using the same material as the conducting film 59. Further, the dummy electrode 613b is electrically connected to the wire 623 at the same potential as the movable structure 80. Accordingly, an electrostatic force generated when the silicon substrate to be the functional device element 8 and the base substrate 2 are anodically bonded may be reduced and sticking of the silicon substrate to the base substrate 2 may be effectively suppressed.

The physical quantity sensor 1b detects an acceleration in the following manner. That is, when an acceleration in the X-axis directions is applied to the physical quantity sensor 1b, the movable part 83 is displaced in the in-plane directions (X-axis directions) based on the magnitude of the acceleration. With the displacement, the gaps between the movable electrode fingers 832 and the first fixed electrode fingers 88 and the gaps between the movable electrode fingers 832 and the second fixed electrode fingers 89 respectively change. With the displacement, capacitances between the movable electrode fingers 832 and the first fixed electrode fingers 88 and capacitances between the movable electrode fingers 832 and the second fixed electrode fingers respectively change. Accordingly, the magnitude and direction of the acceleration may be detected based on the differences between the capacitances (differential detection method).

In the physical quantity sensor 1b, as described above, the dummy electrode 613b and the conducting film 59 are formed using the same material, and the difference in work function between the dummy electrode 613b and the conducting film 59 may be made substantially zero. Accordingly, contact charging between the dummy electrode 613b and the conducting film 59 may be reduced, and thus, for example, when the movable part 83 is displaced into contact with the dummy electrode 613b by application of the acceleration in the vertical directions (Z-axis directions), sticking of the movable part 83 to the base substrate 2 may be reduced. As another advantage, if an outgas is generated within an internal space S and the outgas adheres to the surfaces of the dummy electrode 613b and the conducting film 59, these surface states are maintained in the same charged state with each other. Accordingly, the difference between work functions over time may be reduced.

According to the third embodiment, the same advantages as those of the above described first embodiment may be offered, and the physical quantity sensor 1b that may detect an acceleration in the in-plane directions of the movable part 83 may be provided.

### Physical Quantity Sensor Apparatus

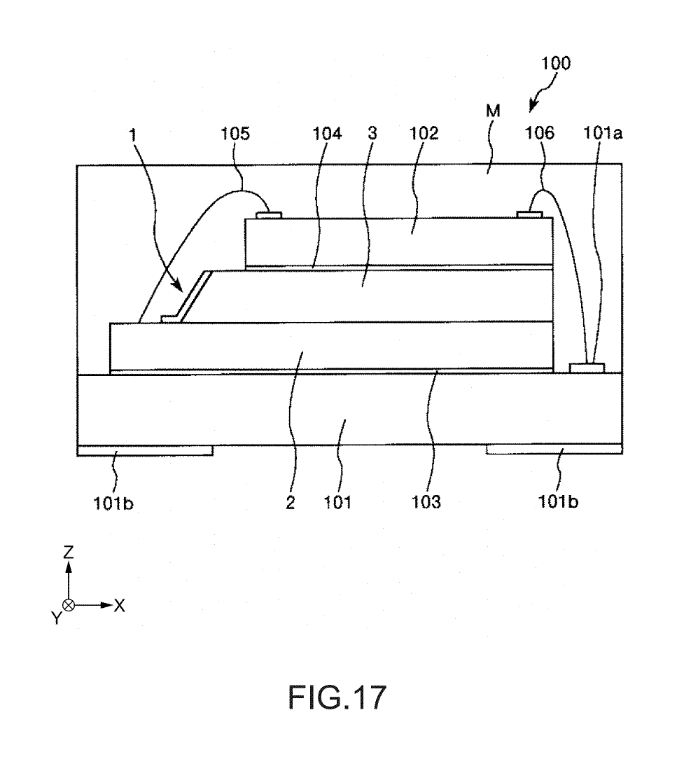

Next, a physical quantity sensor apparatus 100 to which the physical quantity sensor 1, 1a, 1b is applied according to one embodiment of the invention will be explained with reference to FIG. 17. As below, a configuration to which the physical quantity sensor 1 is applied will be explained as an example.

FIG. 17 is a sectional view showing a configuration of the physical quantity sensor apparatus.

As shown in FIG. 17, the physical quantity sensor apparatus 100 has a substrate 101, the physical quantity sensor 1 fixed to the substrate 101 via an adhesive layer 103, and an IC chip 102 as an electronic component fixed to the physical quantity sensor 1 via an adhesive layer 104. The physical quantity sensor 1 and the IC chip 102 are molded by a mold material M. Note that, as the adhesive layers 103, 104, e.g. solder, silver paste, resin adhesive agents (die attach), or the like may be used. As the mold material M, e.g. a thermosetting epoxy resin may be used, and molding may be performed by a transfer molding method, for example.

A plurality of terminals 101a are placed on the upper surface of the substrate 101 and a plurality of mounting terminals 101b connected to the terminals 101a via internal wiring (not shown) are placed on the lower surface. The substrate 101 is not particularly limited, but e.g. a silicon substrate, glass epoxy substrate, or the like may be used.

The IC chip 102 includes e.g. a drive circuit that drives the physical quantity sensor 1, a detection circuit that detects an acceleration from a differential signal, an output circuit that converts a signal from the detection circuit into a predetermined signal and outputs the signal, etc. The IC chip 102 is electrically connected to the terminals 631, 632, 633 (not shown) of the physical quantity sensor 1 via bonding wires 105 and electrically connected to the terminals 101a of the substrate 101 via bonding wires 106.

The physical quantity sensor apparatus 100 includes the physical quantity sensor 1 having higher detection accuracy and has better performance.

### Electronic Apparatuses

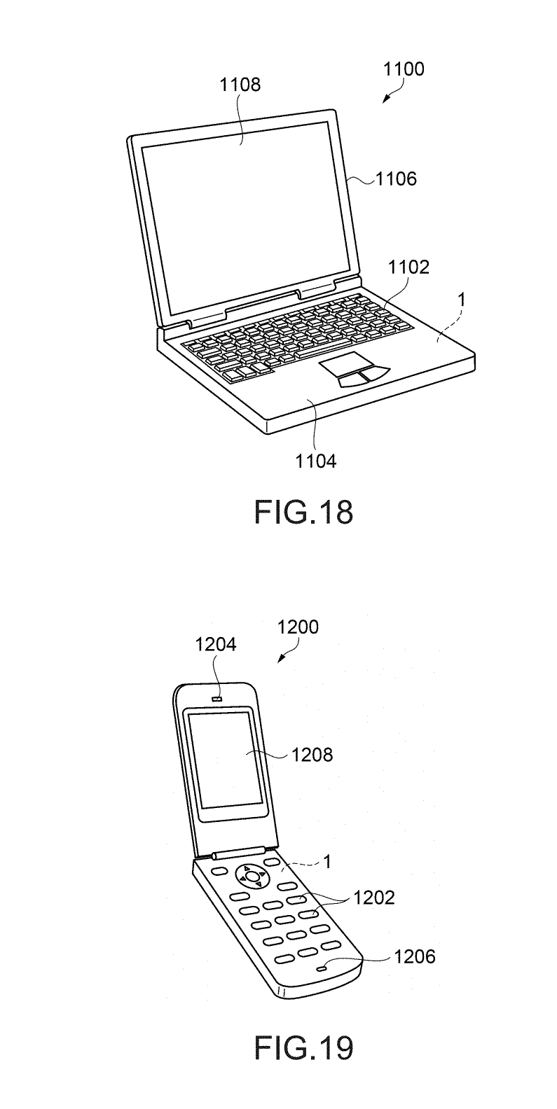

Next, electronic apparatuses to which the physical quantity sensor 1, 1a, 1b is applied according to one embodiment of the invention will be explained with reference to FIGS. 18, 19, and 20. As below, configurations to which the physical quantity sensor 1 is applied will be explained as examples.

FIG. 18 is a perspective view showing a configuration of a mobile (or notebook) personal computer as the electronic apparatus to which the physical quantity sensor is applied.

In the drawing, a personal computer 1100 includes a main body unit 1104 having a keyboard 1102 and a display unit 1106 having a display part 1108, and the display unit 1106 is rotatably supported with respect to the main body unit 1104 via a hinge structure part. The personal computer 1100 contains the physical quantity sensor 1 that functions as an acceleration sensor.

FIG. 19 is a perspective view showing a configuration of a cell phone (including PHS) as the electronic apparatus to which the physical quantity sensor is applied.

In the drawing, a cell phone 1200 includes an antenna (not shown), a plurality of operation buttons 1202, an earpiece 1204, and a mouthpiece 1206, and a display unit 1208 is placed between the operation buttons 1202 and the earpiece 1204. The cell phone 1200 contains the physical quantity sensor 1 that functions as an acceleration sensor.

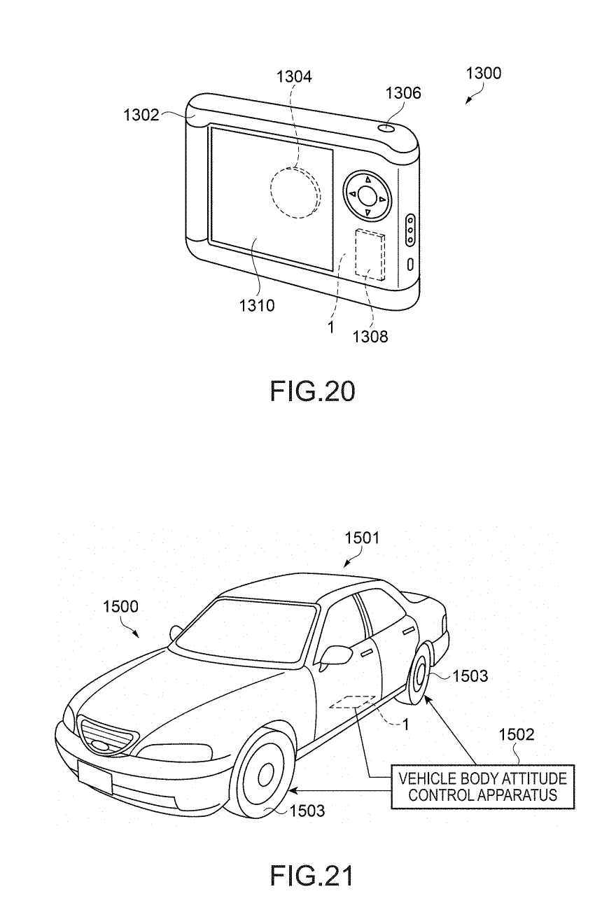

FIG. 20 is a perspective view showing a configuration of a digital still camera as the electronic apparatus to which the physical quantity sensor is applied.

A display unit 1310 is provided on the back surface of a case (body) 1302 in a digital still camera 1300 and adapted to display based on imaging signals by a CCD, and the display unit 1310 functions as a finder that displays a subject as an electronic image. Further, a light receiving unit 1304 including an optical lens (imaging system), CCD, etc. is provided on the front side (the rear surface side in the drawing) of the case 1302. A photographer checks a subject image displayed on the display unit 1310 and presses a shutter button 1306, and then, the imaging signals of the CCD at the moment are transferred to and stored in a memory 1308. The digital still camera 1300 contains the physical quantity sensor that functions as an acceleration sensor for image stabilization.

The above described electronic apparatuses include the physical quantity sensors 1 having higher detection accuracy and have better performance.

Note that the electronic apparatus may be applied not only to the personal computer 1100 in FIG. 18, the cell phone 1200 in FIG. 19, and the digital still camera 1300 but also to a smart phone, table terminal, timepiece, wearable terminal such as a head mounted display, inkjet ejection apparatus (e.g. inkjet printer), laptop personal computer, television, video camera, video tape recorder, car navigation system, pager, personal digital assistance (with or without communication function), electronic dictionary, calculator, electronic game machine, word processor, work station, videophone, security television monitor, electronic binoculars, POS terminal, medical apparatus (e.g., electronic thermometer, sphygmomanometer, blood glucose meter, electrocardiographic measurement apparatus, ultrasonic diagnostic apparatus, or electronic endoscope), fish finder, various measurement instruments, meters and gauges (e.g., meters for vehicles, aircrafts, and ships), flight simulator, etc.

### Vehicle

Next, a vehicle to which the physical quantity sensor 1, 1a, 1b is applied according to one embodiment of the invention will be explained with reference to FIG. 21. As below, a configuration to which the physical quantity sensor 1 is applied will be explained as an example.

FIG. 21 is a perspective view showing an automobile as the vehicle to which the physical quantity sensor is applied.

As shown in FIG. 21, an automobile 1500 contains the physical quantity sensor 1, and may detect an attitude of a vehicle body 1501 by the physical quantity sensor 1. The detection signal of the physical quantity sensor 1 is supplied to a vehicle body attitude controlier 1502, and the vehicle body attitude controlier 1502 may detect the attitude of the vehicle body 1501 based on the signal, and controls hardness of the suspension and control brakes of individual wheels according to the detection result. Further, the physical quantity sensor 1 may be widely applied to electronic control units (ECUs) including keyless entry, an immobilizer, car navigation system, car air-conditioner, antilock brake system (ABS), airbag, tire pressure monitoring system (TPMS), engine control, and battery monitor for hybrid car or electric car.

As above, the physical quantity sensors 1, 1a, 1b, the physical quantity sensor apparatus 100, the electronic apparatuses 1100, 1200, 1300, and the vehicle 1500 are explained based on the illustrated embodiments, however, the invention is not limited to those. The configurations of the respective parts may be replaced by arbitrary configurations having the same functions. Further, other arbitrary configurations may be added to the invention.

In the above described embodiments, the configurations in which the physical quantity sensor 1, 1a, 1b has the single device element within the internal space are explained, however, the number of device elements placed within the internal space is not particularly limited. For example, two of the functional device elements 8 of the above described third embodiment are placed for detection of accelerations along the X-axis and the Y-axis and one of the functional device element 5 of the above described first embodiment is further placed for detection of an acceleration along the Z-axis, and thereby, a physical quantity sensor that may independently detect the accelerations along the X-axis, Y-axis, Z-axis is obtained. Further, a functional device element that may detect an angular velocity is added, and thereby, the physical quantity sensor may be utilized as a composite sensor that may detect the accelerations and the angular velocity.

The physical quantity detected by the physical quantity sensor is not limited to the acceleration, but may be e.g. an angular velocity, pressure, or the like. The configuration of the physical quantity sensor is not limited to the above described configurations, but may be any configuration that may detect a physical quantity, e.g. a flap-type physical quantity sensor or parallel plate-type physical quantity sensor.

The entire disclosure of Japanese Patent Application No. 2017-184450, filed Sep. 26, 2017 is expressly incorporated by reference herein.

What is claimed is:

1. A physical quantity sensor comprising:
a substrate;
a movable part placed to be displaceable with respect to the substrate;
a supporting part that supports the movable part;
an electrode provided on the movable part side of the substrate and placed to face the movable part;
a first conducting part provided on the substrate side of the movable part and placed to face the electrode; and
a second conducting part provided on the substrate side of the supporting part,
wherein the first conducting part and the second conducting part are connected by a third conducting part.

2. The physical quantity sensor according to claim 1, wherein the electrode and the first conducting part are formed using the same material.

3. The physical quantity sensor according to claim 1, wherein the third conducting part is provided on the substrate side of a coupling part that couples the movable part and the supporting part.

4. The physical quantity sensor according to claim 1, wherein the first conducting part and the third conducting part are formed using the same material.

5. The physical quantity sensor according to claim 1, wherein the movable part has a first movable member located on one side and a second movable member located on the other side in which turning moment at application of an acceleration in a direction of an arrangement of the substrate and the movable part is larger than that of the first movable member, and
the first movable member and the second movable member seesaw-swing with respect to the substrate.

6. The physical quantity sensor according to claim 5, wherein the electrode has a first electrode placed to face the first movable member and a second electrode placed to face the second movable member.

7. The physical quantity sensor according to claim 1, wherein the movable part has a base displaceable in in-plane directions of the movable part with respect to the substrate, and a movable electrode portion provided to project from the base.

8. The physical quantity sensor according to claim 7, wherein the electrode is at the same potential as the movable part.

9. A physical quantity sensor apparatus comprising:
the physical quantity sensor according to claim 1; and
an electronic component electrically connected to the physical quantity sensor.

10. A physical quantity sensor apparatus comprising:
the physical quantity sensor according to claim 2; and
an electronic component electrically connected to the physical quantity sensor.

11. A physical quantity sensor apparatus comprising:
the physical quantity sensor according to claim 3; and
an electronic component electrically connected to the physical quantity sensor.

12. A physical quantity sensor apparatus comprising:
the physical quantity sensor according to claim 4; and
an electronic component electrically connected to the physical quantity sensor.

13. An electronic apparatus comprising the physical quantity sensor according to claim 1.

14. An electronic apparatus comprising the physical quantity sensor according to claim 2.

15. An electronic apparatus comprising the physical quantity sensor according to claim 3.

16. An electronic apparatus comprising the physical quantity sensor according to claim 4.

17. A vehicle comprising the physical quantity sensor according to claim 1.

18. A vehicle comprising the physical quantity sensor according to claim 2.

19. A vehicle comprising the physical quantity sensor according to claim 3.

20. A vehicle comprising the physical quantity sensor according to claim 4.
